(19) United States
(12) Patent Application Publication
(10) Pub. No.: US 2026/0299106 A1
(43) Pub. Date: Oct. 1, 2026

(54) OBJECT DETECTION SYSTEM AND OBJECT DETECTION METHOD

(71) Applicant: Renesas Electronics Corporation, Tokyo (JP)

(72) Inventors: Kazuo NAKAHARA, Tokyo (JP); Takafumi KINOSHITA, Tokyo (JP)

(21) Appl. No.: 19/532,771

(22) Filed: Feb. 6, 2026

(30) Foreign Application Priority Data
Mar. 26, 2025 (JP) 2025-052135

(51) Int. Cl. G01S 13/04; G01S 13/34; G01S 13/931

(52) U.S. Cl. CPC G01S 13/04; G01S 13/345; G01S 13/931

(57) ABSTRACT

The determination signal insertion unit inserts a determination signal indicating the result of the determination into the signal included in the first transmission wave when it is determined by the waveform discrimination unit that the electromagnetic wave is the first transmission wave transmitted from a second mobile body. The second transmitting unit transmits the second transmission wave containing the signal into which the determination signal is inserted. The second receiving unit receives the reflected wave generated by the reflection of the second transmission wave by an object. The waveform determination unit determines whether the reflected wave is due to the first transmission wave. When it is determined by the waveform determination unit that the reflected wave is due to the first transmission wave, the first transmitting unit transmits a third transmission wave containing the signal included in the reflected wave to the second mobile body.

### CROSS-REFERENCE TO RELATED APPLICATIONS

The disclosure of Japanese Patent Application No. 2025-052135 filed on Mar. 26, 2025, including the specification, drawings and abstract is incorporated herein by reference in its entirety.

### BACKGROUND

The present disclosure relates to an object detection system mounted on a mobile body such as a vehicle or the like, and a related object detection method, particularly to a system and method for detecting objects using electromagnetic waves. In the improvement of traffic safety and the development of autonomous driving technology, the elimination of blind spots in vehicles is an important issue. Conventionally, methods such as semi-concealment display of surrounding vehicles using cameras or LiDAR (Light Detection And Ranging) and integration of camera images from multiple vehicles have been proposed to address this issue. However, these technologies assume the spread of future technologies and infrastructure such as advanced object recognition capabilities, shared databases, and V2X communication frameworks, and their feasibility is accompanied by uncertainty.

There are disclosed techniques listed below.
[Patent Document 1] Japanese Unexamined Patent Application Publication No. 2023-69326

In Patent Document 1, a collision avoidance system is proposed, and the collision avoidance system is equipped with a proximity vehicle communication system for inter-vehicle communication with other nearby vehicles. The proximity vehicle communication system performs wireless communication between the host vehicle and other vehicles, informs each other of their positions, calculates the distance of approaching vehicles based on the obtained data information, and has the function of notifying the driver.

However, there are several challenges to realize the above system.
To achieve efficient and safe communication between different vehicles, standardized communication protocols are necessary.
It is necessary to ensure compatibility between various vehicle manufacturers and communication devices.
It is necessary to build a communication system that considers security and personal information protection.

### SUMMARY

In view of the above, there is a challenge to propose a method that does not require new communication equipment. Other challenges and novel features will become apparent from the description of this specification and the accompanying drawings.

An object detection system according to one embodiment is mounted on a mobile body and includes a first receiving unit, a first transmitting unit, a second receiving unit, a second transmitting unit, a waveform determination unit, and a determination signal insertion unit. The first receiving unit receives electromagnetic wave. The waveform determination unit determines whether the electromagnetic wave received by the first receiving unit is first transmission wave transmitted from a second mobile body different from the first mobile body. The determination signal insertion unit inserts a determination signal indicating the result of the determination into the signal contained in the first transmission wave when the electromagnetic wave is determined by the waveform determination unit to be first transmission wave transmitted from the second mobile body. The second transmitting unit transmits a second transmission wave containing the signal into which the determination signal has been inserted. The second receiving unit receives a reflected wave generated by the reflection of the second transmission wave by an object. The waveform determination unit determines whether the reflected wave is due to the first transmission wave. When the reflected wave is determined by the waveform determination unit to be due to the first transmission wave, the first transmitting unit transmits a third transmission wave containing the signal included in the reflected wave to the second mobile body.

In the object detection method according to one embodiment, a first receiving unit receives electromagnetic wave. The waveform determination unit determines whether the electromagnetic wave received by the first receiving unit is first transmission wave transmitted from a second mobile body different from the first mobile body. The determination signal insertion unit inserts a determination signal indicating the result of the determination into the signal contained in the first transmission wave when the electromagnetic wave is determined by the waveform determination unit to be first transmission wave transmitted from the second mobile body. The second transmitting unit transmits a second transmission wave containing the signal into which the determination signal has been inserted. The second receiving unit receives a reflected wave generated by the reflection of the second transmission wave by an object. The waveform determination unit determines whether the reflected wave is due to the first transmission wave. The first transmitting unit transmits a third transmission wave containing the signal included in the reflected wave to the second mobile body when the reflected wave is determined by the waveform determination unit to be due to the first transmission wave.

The object detection system and object detection method according to the above embodiment realize an object detection system and object detection method that do not require new communication equipment.

### BRIEF DESCRIPTION OF THE DRAWINGS

FIG. 1 is a schematic diagram showing an example of a situation in which the object detection system according to one embodiment is used.

FIG. 2 is a schematic diagram showing electromagnetic waves traveling between each detection unit and between the detection unit and the object in the situation of FIG. 1.

FIG. 3 is a diagram showing the functional blocks of the object detection system according to the first embodiment and the functional blocks of related elements.

FIG. 4 is a flowchart of the object detection method according to the first embodiment.

FIG. 5 is a diagram showing the data structure of transmission signals used in conventional radar.

FIG. 6 is a diagram showing the data structure of transmission signals with inserted discrimination signals in the object detection method according to one embodiment.

FIG. 7 is a diagram showing the frequency characteristics of the transmission signals shown in FIG. 5.

FIG. 8 is a diagram showing the frequency characteristics of the transmission signals shown in FIG. 6.

FIG. 9 is a graph showing the delay of electromagnetic waves finally received when detecting an object via another vehicle using radar.

FIG. 10 is a graph showing the elimination of the delay of electromagnetic waves finally received by the object detection method according to the second embodiment.

FIG. 11 is a diagram showing the functional blocks of the object detection system according to the second embodiment and the functional blocks of related elements.

FIG. 12 is a flowchart of the object detection method according to the second embodiment.

### DETAILED DESCRIPTION

Below, each embodiment will be described with reference to the drawings. However, each embodiment is an example of the system, method, etc. disclosed in this specification, and systems, methods, etc. obtained by appropriately modifying each embodiment by those skilled in the art are also included within the scope of the disclosure of this specification. In the drawings, the same or corresponding elements are denoted by the same reference numerals, and explanations are omitted as necessary for simplification.

### First Embodiment

### <Overview>

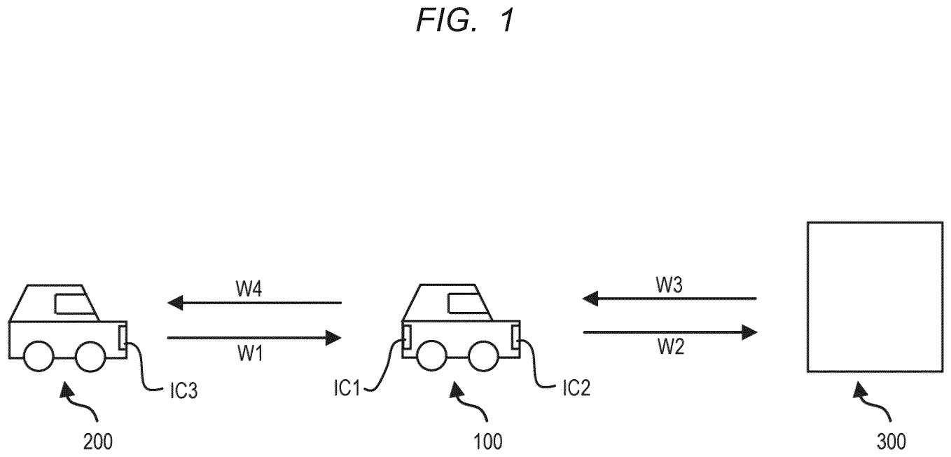

FIG. 1 is a schematic diagram showing an example of a situation in which the object detection system according to one embodiment is used. Vehicle 100 is traveling ahead of vehicle 200, and in front of vehicle 100, there is an object 300, which may be another vehicle, an obstacle, or a pedestrian, etc. (In this specification, humans, animals, etc. are also considered examples of objects.) In each embodiment, vehicle 100 and vehicle 200 do not need to be facing the same direction, and each vehicle may be facing any direction. The position of vehicle 100 and vehicle 200 is not limited to a front-rear positional relationship and may be any positional relationship (each embodiment is applicable even when an oncoming vehicle turns right on a one-lane road or when vehicle 100 cuts in between object 300 and vehicle 200).

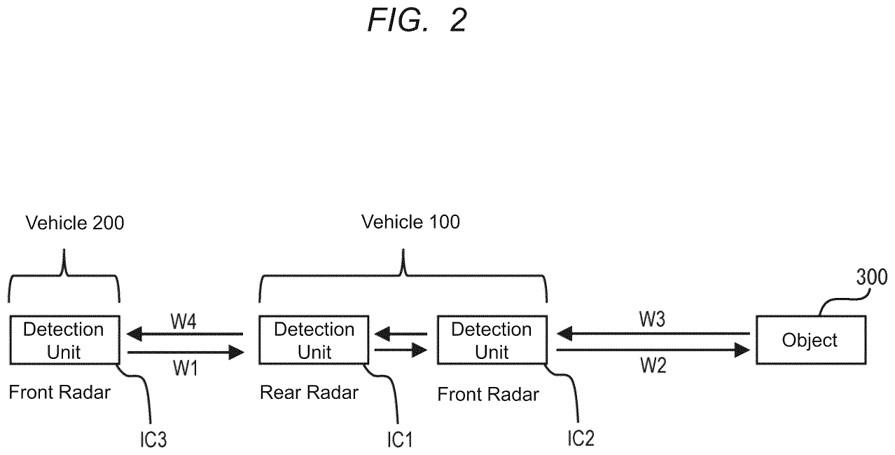

On the rear side of vehicle 100, a detection unit IC1, which is a radar IC (Integrated Circuit), is arranged, and on the front side of vehicle 100, a detection unit IC2, which is a radar IC, is arranged. On the front side of vehicle 200, a detection unit IC3, which is a radar IC, is arranged. FIG. 2 is a schematic diagram showing electromagnetic waves traveling between respective detection units and between the detection unit and the object in the situation of FIG. 1.

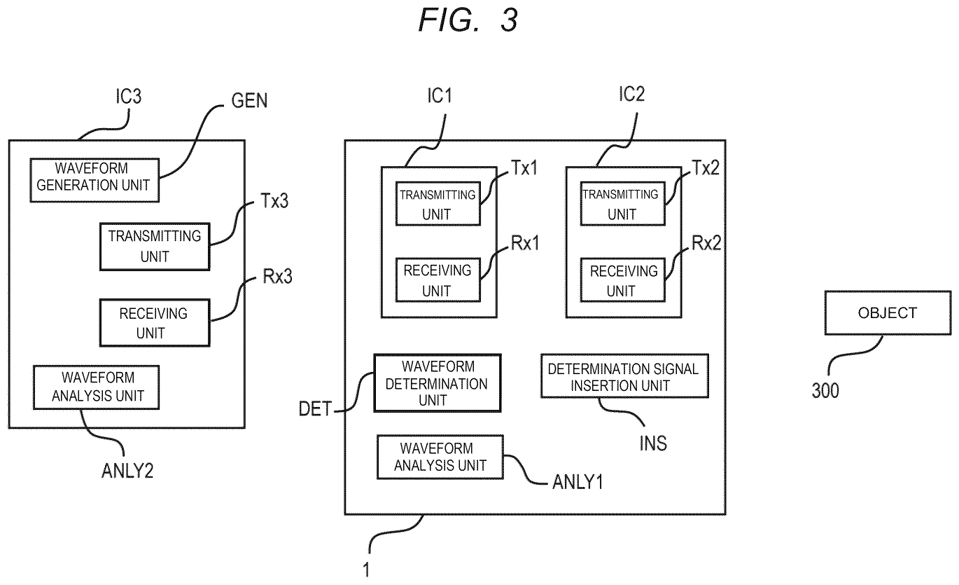

In the normal object detection operation of vehicle 100, detection unit IC2 transmits electromagnetic wave W2 to object 300 and receives electromagnetic wave W3 (reflected wave) generated by the reflection of electromagnetic wave W2 by object 300. The object detection system 1 mounted on vehicle 100 (see FIG. 3 below) detects the distance between vehicle 100 and object 300, the shape of object 300, etc., by analyzing the waveform of electromagnetic wave W3.

In the first embodiment, the object detection system 1 further has the function of relaying electromagnetic waves between vehicle 200 and object 300. When detection unit IC3 of vehicle 200 transmits electromagnetic wave W1 for object detection to object 300, the presence of vehicle 200 may prevent electromagnetic wave W1 from reaching object 300, and in that case, vehicle 200 cannot detect object 300. However, in this embodiment, vehicle 100 relays electromagnetic wave W1 and transmits electromagnetic wave W2, which includes the signal contained in electromagnetic wave W1, to object 300. Furthermore, vehicle 100 relays electromagnetic wave W3 generated by the reflection of electromagnetic wave W2 by object 300, and transmits electromagnetic wave W4, which includes the signal contained in electromagnetic wave W3, to detection unit IC3. Vehicle 200 detects the distance between vehicle 200 and object 300, the shape of object 300, etc., by analyzing the waveform of electromagnetic wave W4. In the following, each embodiment is described assuming that the electromagnetic wave is radio wave as an example, but the electromagnetic wave disclosed in this specification may be electromagnetic wave of any wavelength. In the description of each embodiment, it may be described that electromagnetic waves or radio waves, etc., pass through vehicle 100, etc., but “pass through” here includes the transmission of electromagnetic waves or radio waves, etc., from vehicle 100, etc., after the signal contained in the received electromagnetic waves or radio waves, etc., is modified (insertion of determination signal, frequency correction, etc.) in vehicle 100, etc. Similarly, “relay” in each embodiment also includes transmitting electromagnetic waves or radio waves, etc., after appropriately modifying the signal contained in the received electromagnetic waves or radio waves, etc.

### <Configuration of Object Detection System>

FIG. 3 is a diagram showing the functional blocks of the object detection system according to the first embodiment and the functional blocks of related elements. The object detection system 1 mounted on vehicle 100 includes detection unit IC1, detection unit IC2, waveform determination unit DET, determination signal insertion unit INS, and waveform analysis unit ANLY1. Detection unit IC1 includes a transmitting unit Tx1 and a receiving unit Rx1. Detection unit IC2 includes a transmitting unit Tx2 and a receiving unit Rx2. Furthermore, detection unit IC3 mounted on vehicle 200 includes waveform generation unit GEN, transmitting unit Tx3, receiving unit Rx3, and waveform analysis unit ANLY2. In the block diagram of FIG. 3, only the elements related to the relay function of the object detection system 1 are illustrated, and the object detection system 1 may include various other elements. For example, the object detection system 1 may be equipped with a waveform generation unit similar to the waveform generation unit GEN included in the detection unit IC3 of the vehicle 200.

Transmission units Tx1, Tx2, Tx3 are radio wave transmission antennas, and reception units Rx1, Rx2, Rx3 are radio wave reception antennas. Detection unit IC1 is configured as a radar IC including transmission unit Tx1, reception unit Rx1, and circuits for radar signal processing, and performs transmission and reception of radio waves. Detection unit IC2 is configured as a radar IC including transmission unit Tx2, reception unit Rx2, and circuits for radar signal processing, and performs transmission and reception of radio waves. Detection unit IC3 is configured as a radar IC including transmission unit Tx3, reception unit Rx3, and circuits for radar signal processing, and performs transmission and reception of radio waves. As previously mentioned, detection unit IC3 further includes a waveform generation unit GEN and a waveform analysis unit ANLY2. Waveform generation unit GEN is a radio wave generator including oscillation circuits etc. for generating radio waves including radar signals. Waveform analysis unit ANLY2 is a waveform analyzer including analysis circuits etc. for analyzing the waveform of radio waves.

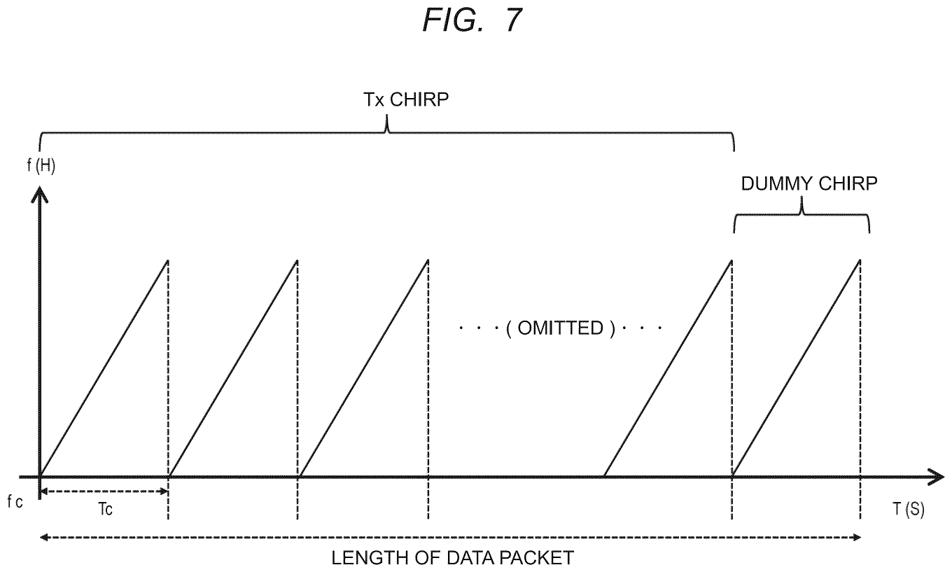

Waveform determination unit DET is a waveform discriminator including determination circuits for determining, from the waveform etc. of the received radio wave, whether the received radio wave is (1) a radio wave transmitted from vehicle 200, (2) a radio wave transmitted from vehicle 200, reflected by object 300 via vehicle 100, or (3) a radio wave transmitted from vehicle 100, reflected by object 300, and returned to vehicle 100. In one example, this determination can be performed by detecting the length of the chirp signal duration Tc in FIG. 7 and the like described later. In this case, by setting the duration Tc of the radio wave generated or transmitted by vehicle 100 and the duration Tc of the radio wave generated or transmitted by vehicle 200 to different lengths, waveform determination unit DET can perform the above determination. Specifically, if the radio wave is received by the rear-side reception unit Rx1 of vehicle 100 and the duration Tc matches the duration Tc of the radio wave generated or transmitted by vehicle 200, waveform determination unit DET determines that the radio wave is (1) a radio wave transmitted from vehicle 200. Furthermore, if the radio wave is received by the front-side reception unit Rx2 of vehicle 100 and the duration Tc matches the duration Tc of the radio wave generated or transmitted by vehicle 200, waveform determination unit DET determines that the radio wave is (2) a radio wave transmitted from vehicle 200, reflected by object 300 via vehicle 100. Additionally, if the radio wave is received by the front-side reception unit Rx2 of vehicle 100 and the duration Tc matches the duration Tc of the radio wave generated or transmitted by vehicle 100, waveform determination unit DET determines that the radio wave is (3) a radio wave transmitted from vehicle 100, reflected by object 300, and returned to vehicle 100.

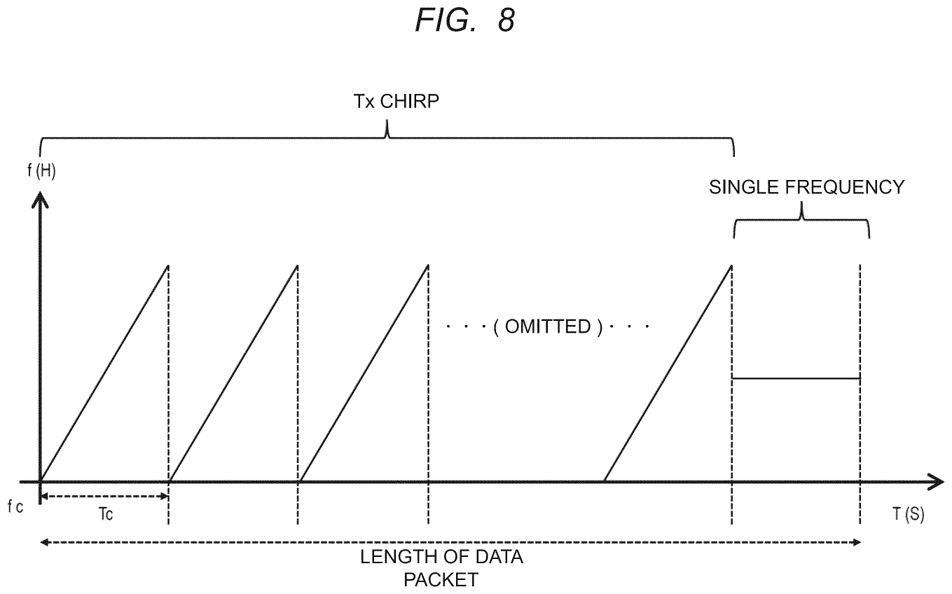

Determination signal insertion unit INS is a determination signal inserter including processing circuits etc. for inserting a determination signal indicating the result of determination into the signal contained in the radio wave when waveform determination unit DET determines that the received radio wave is transmitted from vehicle 200. In one example, the signal indicating the result of determination is a single frequency signal shown in FIG. 8 described later.

Waveform analysis unit ANLY1 is a waveform analyzer including analysis circuits etc. for analyzing the waveform of received radio waves.

### <Operational Flow of Object Detection Method>

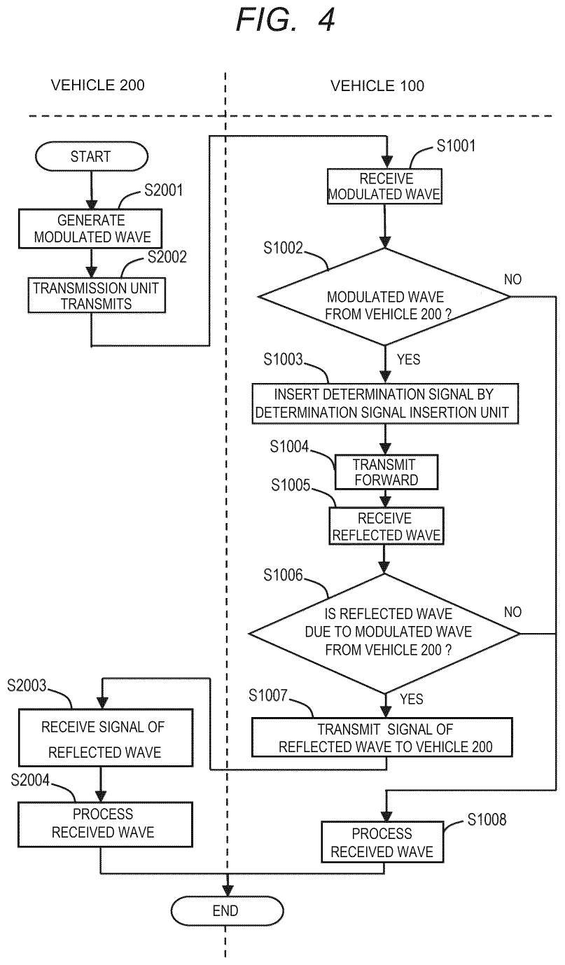

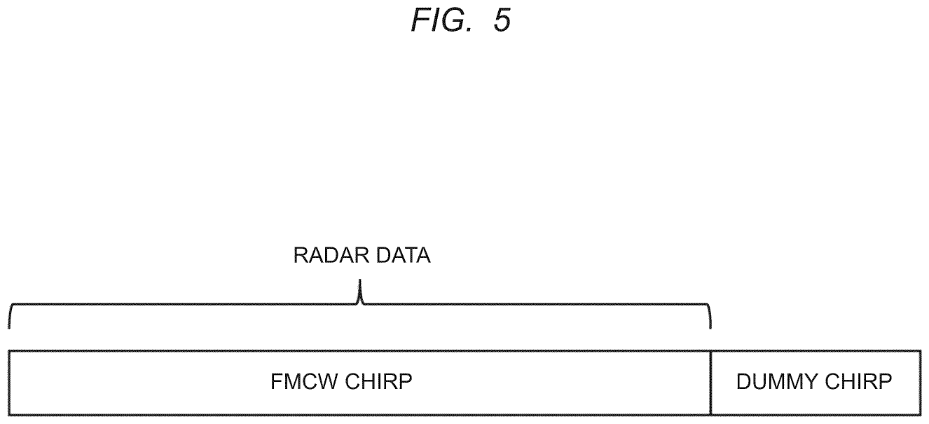

FIG. 4 is a flowchart of the object detection method according to the first embodiment. In step S2001, the waveform generation unit GEN of vehicle 200 generates a modulated wave, which is an electromagnetic wave (radio wave) for radar-based object detection. The data structure of the signal contained in the modulated wave generated here may be, in one example, the data structure of the transmission signal used in conventional radar as shown in FIG. 5. In the data structure of FIG. 5, the length of the data packet is adjusted by inserting dummy chirp signals in addition to the main chirp signal (FMCW: Frequency Modulated Continuous Wave chirp) to meet the requirements for transfer size. The frequency characteristics of the transmission signal shown in FIG. 5 are illustrated in FIG. 7. In step S2002, transmission unit Tx3 transmits the modulated wave forward (in the direction of object 300).

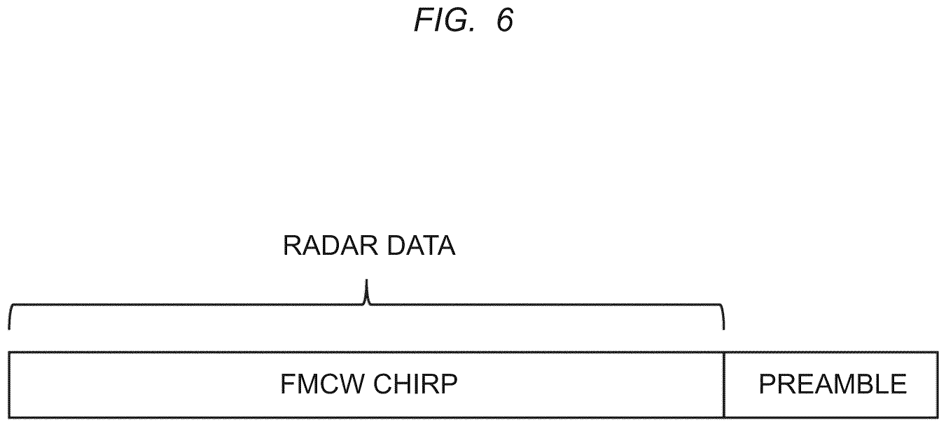

In step S1001, reception unit Rx1 of vehicle 100 receives the modulated wave. The signal contained in the modulated wave is sent to waveform determination unit DET. In step S1002, waveform determination unit DET determines whether the modulated wave received by reception unit Rx1 is a modulated wave transmitted from vehicle 200. If waveform determination unit DET determines that the modulated wave received by reception unit Rx1 is a modulated wave transmitted from vehicle 200 (Yes in the conditional branch of step S1002), the signal contained in the modulated wave is sent to determination signal insertion unit INS, and in step S1003, determination signal insertion unit INS inserts a determination signal indicating the result of determination into the signal contained in the modulated wave. Specifically, determination signal insertion unit INS inserts a determination signal by changing the dummy chirp portion to a preamble signal in the data structure of the modulated wave shown in FIG. 5. FIG. 6 shows the data structure of the signal after the determination signal is inserted into the signal of the modulated wave. The preamble signal shown in FIG. 6 is, in one example, a single frequency signal. FIG. 7 shows the frequency characteristics of the signal after such a determination signal is inserted.

In step S1002, if waveform determination unit DET determines that the modulated wave received by reception unit Rx1 is not a modulated wave transmitted from vehicle 200 (No in the conditional branch of step S1002), the signal contained in the modulated wave is sent to waveform analysis unit ANLY1, and in step S1008, waveform analysis unit ANLY1 analyzes the signal contained in the modulated wave. Waveform analysis by waveform analysis unit ANLY1 may be similar to the analysis of reflected waves in conventional radar, and in one example, waveform analysis unit ANLY1 generates an IF (Intermediate Frequency) signal and analyzes the received waveform. The signal indicating the analysis result is appropriately utilized by e.g., being transmitted outside the object detection system 1.

In step S1002, if waveform determination unit DET determines that the modulated wave received by reception unit Rx1 is a modulated wave transmitted from vehicle 200 (Yes in the conditional branch of step S1002), and after the insertion of the determination signal in step S1003, the signal after the determination signal is inserted is sent to transmission unit Tx2. Transmission unit Tx2 transmits the electromagnetic wave containing the signal after the determination signal is inserted forward (in the direction of object 300) (step S1004). The electromagnetic wave transmitted in step S1004 is reflected by object 300, and reception unit Rx2 receives the reflected wave caused by the reflection (step S1005).

In step S1006, waveform determination unit DET determines whether the reflected wave is due to the modulated wave from vehicle 200, in other words, whether the reflected wave is a radio wave transmitted from vehicle 200, reflected by object 300 via vehicle 100. If waveform determination unit DET determines that the reflected wave is due to the modulated wave from vehicle 200 (Yes in the conditional branch of step S1006), transmission unit Tx1 transmits the radio wave containing the signal included in the reflected wave to vehicle 200 (step S1007).

In step S1006, if waveform determination unit DET determines that the reflected wave is not due to the modulated wave from vehicle 200 (No in the conditional branch of step S1006), the signal contained in the reflected wave is sent to waveform analysis unit ANLY1, and in step S1008, waveform analysis unit ANLY1 analyzes the signal contained in the reflected wave. The signal indicating the analysis result is appropriately utilized by e.g., being transmitted outside the object detection system 1.

In step S1006, if waveform determination unit DET determines that the reflected wave is due to the modulated wave from vehicle 200 (Yes in the conditional branch of step S1006), and transmission to vehicle 200 is performed in step S1007, reception unit Rx3 receives the radio wave containing the signal included in the reflected wave (step S2003). The signal contained in the radio wave is sent to waveform analysis unit ANLY2, and in step S2004, waveform analysis unit ANLY2 analyzes the signal contained in the radio wave. Waveform analysis by waveform analysis unit ANLY2 may be similar to the analysis of reflected waves in conventional radar, and in one example, waveform analysis unit ANLY2 generates an IF (Intermediate Frequency) signal and analyzes the received waveform. The signal indicating the analysis result is appropriately utilized by e.g., being transmitted outside detection unit IC3.

### Main Effects of First Embodiment

By using object detection system 1 and object detection method according to the first embodiment, it is possible to detect objects further ahead of the forward vehicle by relaying radar without requiring new communication equipment.

### Second Embodiment

### <Overview>

When relaying radar using object detection system 1 and object detection method according to the first embodiment, there may be delays in the transmitted and received radio waves. Radar calculates distance from the round-trip time of signals, and when this delay time is added to the round-trip time, there may be a problem where the distance to the vehicle or object ahead is calculated as longer than the actual distance. In this case, the system of vehicle 200 mistakenly observes that the object 300 ahead is farther than its actual position. In the second embodiment, when the radio wave transmitted from vehicle 200 passes through vehicle 100, the delay time is adjusted by adding a frequency corresponding to the delay to the chirp signal received by vehicle 100. This allows vehicle 200 to obtain a signal equivalent to the case where vehicle 100 does not exist.

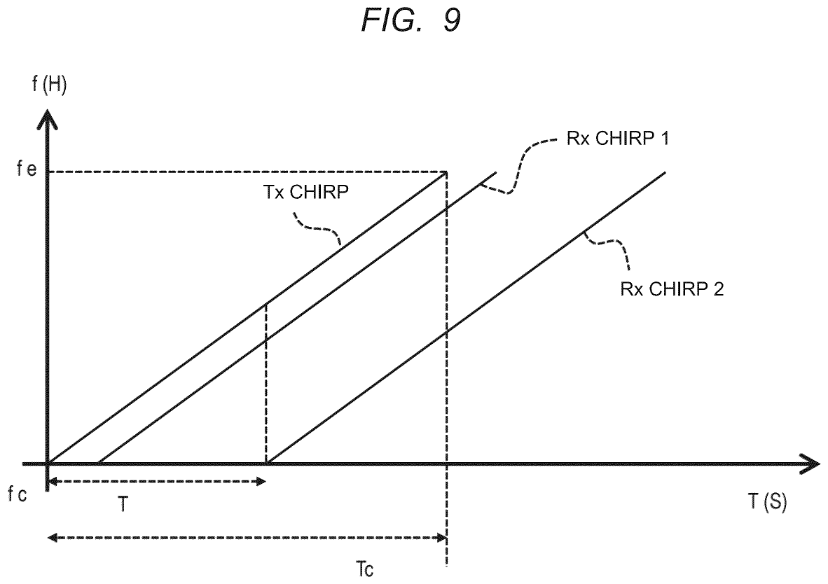

FIG. 9 shows a graph indicating that when an object is detected via another vehicle by radar, the electromagnetic wave finally received is delayed. The vertical axis f(H) represents frequency (unit: Hertz), and the horizontal axis T(S) represents elapsed time (unit: seconds). fc represents the starting frequency of the chirp signal, and Tc represents the duration of the chirp signal. fe represents the maximum frequency of the chirp signal. Tx chirp is the chirp signal of the radio wave transmitted from vehicle 200, Rx chirp 1 is the waveform of the chirp signal transmitted from vehicle 200, reflected by vehicle 100, and received by vehicle 200, and Rx chirp 2 is the waveform of the chirp signal transmitted from vehicle 200, reflected by object 300 via vehicle 100, and received by vehicle 200 via vehicle 100. Rx chirp 2 is a waveform affected by the delay due to passing through vehicle 100, and when calculating the distance between vehicle 200 and object 300 based on time T, a larger distance than the actual distance is obtained.

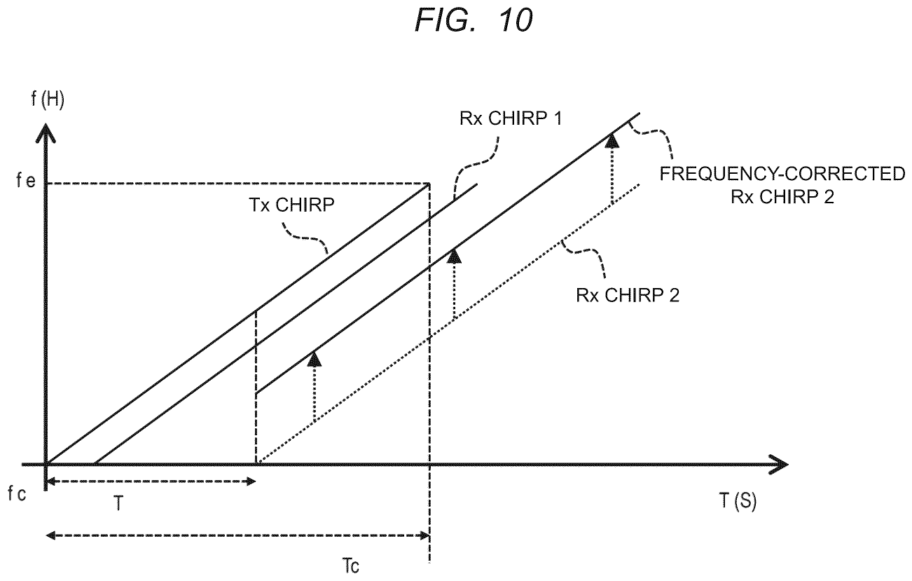

FIG. 10 is a graph showing that the delay effect of the electromagnetic wave finally received is eliminated by the object detection method according to the second embodiment. As indicated by the arrows in FIG. 10, by correcting the frequency of Rx chirp 2 and allowing vehicle 200 to receive the chirp signal with the waveform of the frequency-corrected Rx chirp 2, it becomes possible to accurately calculate the distance between vehicle 200 and object 300 without being affected by the delay due to passing through vehicle 100. The specific magnitude of the frequency added to the frequency of Rx chirp 2 may be theoretically determined based on time theoretically calculated required for processing within vehicle 100 performing the relay, or it may be determined experimentally so that the value of the distance between vehicle 200 and object 300 measured by other methods matches the value of the distance between vehicle 200 and object 300 measured by relaying radar signals according to this embodiment. In one example, assuming that the slope of the chirp signal graph in FIGS. 9 and 10 is (fe-fc)/Tc, and assuming that the processing time in vehicle 100 is

$$Δ T$$

as each of the relay processing time in the direction from vehicle 200 to object 300 and the relay processing time in the direction from object 300 to vehicle 200, then the magnitude of the frequency to be added is expressed as

$$2 Δ T \times ( fe - fc ) / Tc .$$

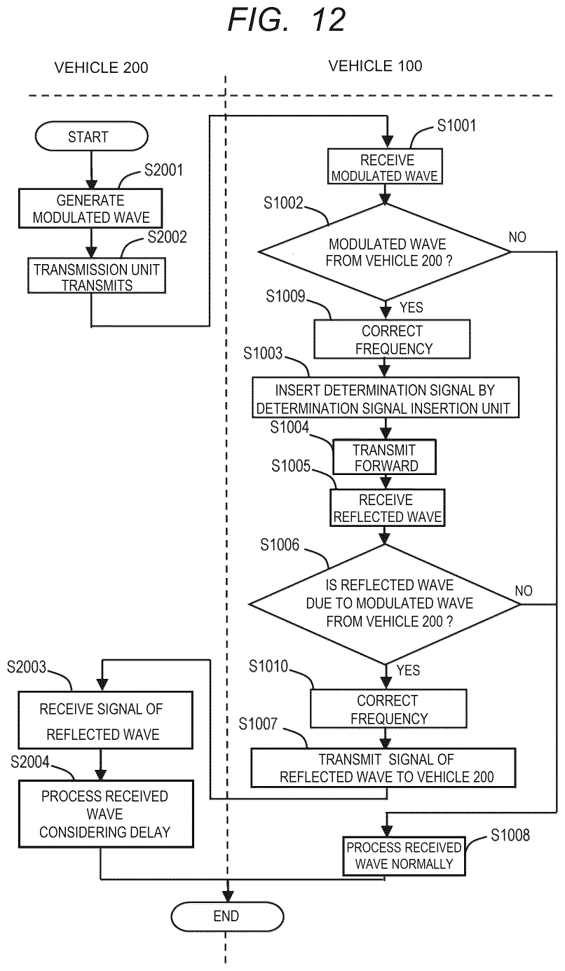

In such an example, in the flow of FIG. 12 described later, the frequency of

$$Δ T \times ( fe - fc ) / Tc$$

is added in steps S1009 and S1010 respectively.

### <Configuration of Object Detection System>

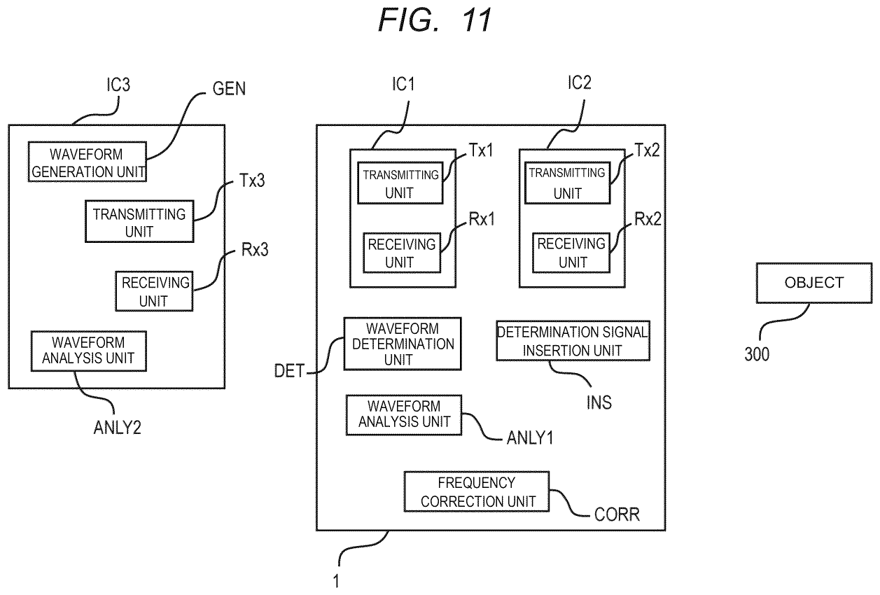

FIG. 11 is a diagram showing the functional blocks of the object detection system according to the second embodiment, and the functional blocks of related elements. The explanation of the configuration similar to that in the first embodiment is omitted. The object detection system 1 according to the second embodiment has a frequency correction unit CORR in addition to the configuration of the first embodiment. The frequency correction unit CORR is a frequency corrector equipped with a frequency correction circuit etc. for correcting the frequency of signals.

### <Operation Flow of Object Detection Method>

FIG. 12 is a flowchart of the object detection method according to the second embodiment. The explanation of parts similar to those in the first embodiment is omitted as appropriate. In step S2001, the waveform generation unit GEN of vehicle 200 generates a modulated wave, which is an electromagnetic wave (radio wave) for object detection by radar. In step S2002, the transmission unit Tx3 transmits the modulated wave forward (in the direction of object 300).

In step S1001, the receiving unit Rx1 of vehicle 100 receives the modulated wave. The signal contained in the modulated wave is sent to the waveform determination unit DET. In step S1002, the waveform determination unit DET determines whether the modulated wave received by the receiving unit Rx1 is the modulated wave transmitted from vehicle 200. If the modulated wave received by the receiving unit Rx1 is determined by the waveform determination unit DET to be the modulated wave transmitted from vehicle 200 (Yes in the conditional branch of step S1002), in step S1009, the frequency correction unit CORR corrects the frequency by adding, to the frequency of the modulated wave, a frequency of which magnitude corresponds to the delay caused by the modulated wave passing through vehicle 100 before the modulated wave reaches, from vehicle 200, object 300. After step S1009, the signal contained in the modulated wave is sent to the determination signal insertion unit INS, and further in step S1003, the determination signal insertion unit INS inserts a determination signal indicating the result of determination into the signal contained in the modulated wave.

In step S1002, if the modulated wave received by the receiving unit Rx1 is determined by the waveform determination unit DET not to be the modulated wave transmitted from vehicle 200 (No in the conditional branch of step S1002), the signal contained in the modulated wave is sent to the waveform analysis unit ANLY1, and further in step S1008, the waveform analysis unit ANLY1 analyzes the signal contained in the modulated wave. The signal indicating the analysis result is appropriately utilized by e.g., being transmitted outside the object detection system 1.

In step S1002, if the modulated wave received by the receiving unit Rx1 is determined by the waveform determination unit DET to be the modulated wave transmitted from vehicle 200 (Yes in the conditional branch of step S1002), after the frequency correction in step S1009 and the insertion of the determination signal in step S1003 are performed, the signal after the determination signal is inserted is sent to the transmission unit Tx2. The transmission unit Tx2 transmits the electromagnetic wave containing the signal after the determination signal is inserted forward (in the direction of object 300) (step S1004). The electromagnetic wave transmitted in step S1004 is reflected by object 300, and the receiving unit Rx2 receives the reflected wave generated by the reflection (step S1005).

In step S1006, the waveform determination unit DET determines whether the reflected wave is caused by the modulated wave from vehicle 200, in other words, whether the reflected wave is the radio wave transmitted from vehicle 200, which passed through vehicle 100, and reflected by object 300. If the reflected wave is determined by the waveform determination unit DET to be caused by the modulated wave from vehicle 200 (Yes in the conditional branch of step S1006), in step S1010, the frequency correction unit CORR corrects the frequency by adding, to the frequency of the reflected wave, a frequency of which magnitude corresponds to the delay caused by the reflected wave passing through vehicle 100 before the reflected wave reaches, from object 300, vehicle 200. After step S1010, the transmission unit Tx1 transmits the radio wave containing the signal included in the reflected wave to vehicle 200 (step S1007).

In step 1006, if the reflected wave is determined by the waveform determination unit DET not to be caused by the modulated wave from vehicle 200 (No in the conditional branch of step S1006), the signal contained in the reflected wave is sent to the waveform analysis unit ANLY1, and further in step S1008, the waveform analysis unit ANLY1 analyzes the signal contained in the reflected wave. The signal indicating the analysis result is appropriately utilized by e.g., being transmitted outside the object detection system 1.

In step 1006, if the reflected wave is determined by the waveform determination unit DET to be caused by the modulated wave from vehicle 200 (Yes in the conditional branch of step S1006), after the frequency correction in step S1010 and the transmission to vehicle 200 in step S1007 are performed, the receiving unit Rx3 receives the radio wave containing the signal included in the reflected wave (step S2003). The signal contained in the radio wave is sent to the waveform analysis unit ANLY2, and further in step S2004, the waveform analysis unit ANLY2 analyzes the signal contained in the radio wave. Due to the frequency correction of the modulated wave and the reflected wave in steps S1009 and S1010, the reception wave processing in step S2004 becomes reception wave processing in which delay is considered. The signal indicating the analysis result is appropriately utilized e.g., by being transmitted outside the detection unit IC3.

### Effects of Second Embodiment

By using object detection system 1 and the object detection method according to the second embodiment, it becomes possible to detect objects without being affected by the delay due to radar relay.

Although the invention made by the present inventor has been specifically described based on the embodiment, the present invention is not limited to the as described above embodiments, and it is needless to say that various modifications can be made without departing from the gist thereof.

This specification describes the following configuration.

### Additional Statement 1

An object detection system mounted on a first mobile body, comprising:
a first receiving unit that receives electromagnetic wave;
a first transmitting unit;
a waveform determination unit that determines whether the electromagnetic wave received by the first receiving unit is first transmission wave transmitted from a second mobile body different from the first mobile body;
a determination signal insertion unit that inserts a determination signal indicating the result of the determination into the signal contained in the first transmission wave when the electromagnetic wave is determined by the waveform determination unit to be first transmission wave transmitted from the second mobile body;
a second receiving unit; and
a second transmitting unit that transmits a second transmission wave containing the signal into which the determination signal has been inserted, wherein the second receiving unit receives a reflected wave generated by the reflection of the second transmission wave by an object;
wherein the waveform determination unit determines whether the reflected wave is due to the first transmission wave; and
wherein, when the reflected wave is determined by the waveform determination unit to be due to the first transmission wave, the first transmitting unit transmits a third transmission wave containing the signal included in the reflected wave to the second mobile body.

### Additional Statement 2

The object detection system according to additional statement 1, wherein the signal contained in the first transmission wave includes a chirp signal, and the determination signal includes a single frequency signal.

### Additional Statement 3

The object detection system according to additional statement 1 or 2, comprising a waveform analysis unit that:
analyzes the waveform of the electromagnetic wave when they are determined by the waveform determination unit not to be first transmission wave transmitted from the second mobile body; and
analyzes the waveform of the reflected wave when it is determined by the waveform determination unit not to be due to the first transmission wave.

### Additional Statement 4

The object detection system according to any of additional statements 1 to 3,
wherein the signal contained in the first transmission wave includes a chirp signal; and
wherein the object detection system further comprises a frequency correction unit which, when the electromagnetic wave is determined by the waveform determination unit to be first transmission wave transmitted from the second mobile body, performs frequency correction on the chirp signal.

### Additional Statement 5

The object detection system according to any of additional statements 1 to 4,
wherein the signal contained in the reflected wave includes a chirp signal; and
wherein the object detection system further comprises a frequency correction unit which, when the reflected wave is determined by the waveform determination unit to be due to the first transmission wave, performs frequency correction on the chirp signal.

### Additional Statement 6

The object detection system according to any of additional statements 1 to 5,
wherein the first receiving unit and the first transmitting unit are arranged on the rear side of the first mobile body, and the first receiving unit receives electromagnetic wave transmitted from the rear direction of the first mobile body; and
wherein the second receiving unit and the second transmitting unit are arranged on the front side of the first mobile body, and the second transmitting unit transmits the second transmission wave to the front direction of the first mobile body.

### Additional Statement 7

An object detection method using an object detection system mounted on a first mobile body comprising a first receiving unit, a first transmitting unit, a second receiving unit, a second transmitting unit, a waveform determination unit, and a determination signal insertion unit,
wherein the method comprises:
receiving electromagnetic wave by the first receiving unit;
determining, by the waveform determination unit, whether the electromagnetic wave received by the first receiving unit is first transmission wave transmitted from a second mobile body different from the first mobile body;
inserting, by the determination signal insertion unit, a determination signal indicating the result of the determination into the signal contained in the first transmission wave when the electromagnetic wave is determined by the waveform determination unit to be first transmission wave transmitted from the second mobile body;
transmitting, by the second transmitting unit, a second transmission wave containing the signal into which the determination signal has been inserted;
receiving, by the second receiving unit, a reflected wave generated by the reflection of the second transmission wave by an object;
determining, by the waveform determination unit, whether the reflected wave is due to the first transmission wave; and
transmitting, by the first transmitting unit, a third transmission wave containing the signal included in the reflected wave to the second mobile body when the reflected wave is determined by the waveform determination unit to be due to the first transmission wave.

### Additional Statement 8

The object detection method according to additional statement 7, wherein the signal contained in the first transmission wave includes a chirp signal, and the determination signal includes a single frequency signal.

### Additional Statement 9

The object detection method according to additional statement 7 or 8, wherein the object detection system further comprises a waveform analysis unit, wherein the waveform analysis unit:
analyzes the waveform of the electromagnetic wave when it is determined by the waveform discrimination unit that the electromagnetic wave is not the first transmission wave transmitted from a second mobile body, and
analyzes the waveform of the reflected wave when it is determined by the waveform determination unit that the reflected wave is not due to the first transmission wave.

### Additional Statement 10

The object detection method according to any of additional statements 7 to 9,
wherein the object detection system further comprises a frequency correction unit;
wherein the signal included in the first transmission wave contains a chirp signal; and
wherein the frequency correction unit performs frequency correction on the chirp signal when it is determined by the waveform discrimination unit that the electromagnetic wave is a first transmission wave transmitted from the second mobile body.

### Additional Statement 11

The object detection method according to any of additional statements 7-10,
wherein the object detection system further comprises a frequency correction unit;
wherein the signal included in the reflected wave contains a chirp signal; and
wherein the frequency correction unit performs frequency correction on the chirp signal when it is determined by the waveform determination unit that the reflected wave is due to the first transmission wave.

### Additional Statement 12

The object detection method according to any of additional statements 7 to 11,
wherein the first receiving unit and the first transmitting unit are arranged on the rear side of the first mobile body, and the first receiving unit receives electromagnetic wave transmitted from the rear direction of the first mobile body; and
wherein the second receiving unit and the second transmitting unit are arranged on the front side of the first mobile body, and the second transmitting unit transmits the second transmission wave to the front direction of the first mobile body.

What is claimed is:

1. An object detection system mounted on a first mobile body, comprising:
a first receiving unit that receives electromagnetic wave;
a first transmitting unit;
a waveform determination unit that determines whether the electromagnetic wave received by the first receiving unit is first transmission wave transmitted from a second mobile body different from the first mobile body;
a determination signal insertion unit that inserts a determination signal indicating the result of the determination into the signal contained in the first transmission wave when the electromagnetic wave is determined by the waveform determination unit to be first transmission wave transmitted from the second mobile body;
a second receiving unit; and
a second transmitting unit that transmits a second transmission wave containing the signal into which the determination signal has been inserted,
wherein the second receiving unit receives a reflected wave generated by the reflection of the second transmission wave by an object;
wherein the waveform determination unit determines whether the reflected wave is due to the first transmission wave; and
wherein, when the reflected wave is determined by the waveform determination unit to be due to the first transmission wave, the first transmitting unit transmits a third transmission wave containing the signal included in the reflected wave to the second mobile body.

2. The object detection system according to claim 1, wherein the signal contained in the first transmission wave includes a chirp signal, and the determination signal includes a single frequency signal.

3. The object detection system according to claim 1, comprising a waveform analysis unit that:
analyzes the waveform of the electromagnetic wave when they are determined by the waveform determination unit not to be first transmission wave transmitted from the second mobile body; and
analyzes the waveform of the reflected wave when it is determined by the waveform determination unit not to be due to the first transmission wave.

4. The object detection system according to claim 1,
wherein the signal contained in the first transmission wave includes a chirp signal; and
wherein the object detection system further comprises a frequency correction unit which, when the electromagnetic wave is determined by the waveform determination unit to be first transmission wave transmitted from the second mobile body, performs frequency correction on the chirp signal.

5. The object detection system according to claim 1,
wherein the signal contained in the reflected wave includes a chirp signal; and
wherein the object detection system further comprises a frequency correction unit which, when the reflected wave is determined by the waveform determination unit to be due to the first transmission wave, performs frequency correction on the chirp signal.

6. The object detection system according to claim 1,
wherein the first receiving unit and the first transmitting unit are arranged on the rear side of the first mobile body, and the first receiving unit receives electromagnetic wave transmitted from the rear direction of the first mobile body; and
wherein the second receiving unit and the second transmitting unit are arranged on the front side of the first mobile body, and the second transmitting unit transmits the second transmission wave to the front direction of the first mobile body.

7. An object detection method using an object detection system mounted on a first mobile body comprising a first receiving unit, a first transmitting unit, a second receiving unit, a second transmitting unit, a waveform determination unit, and a determination signal insertion unit,
wherein the method comprises:
receiving electromagnetic wave by the first receiving unit;
determining, by the waveform determination unit, whether the electromagnetic wave received by the first receiving unit is first transmission wave transmitted from a second mobile body different from the first mobile body;
inserting, by the determination signal insertion unit, a determination signal indicating the result of the determination into the signal contained in the first transmission wave when the electromagnetic wave is determined by the waveform determination unit to be first transmission wave transmitted from the second mobile body;
transmitting, by the second transmitting unit, a second transmission wave containing the signal into which the determination signal has been inserted;
receiving, by the second receiving unit, a reflected wave generated by the reflection of the second transmission wave by an object;
determining, by the waveform determination unit, whether the reflected wave is due to the first transmission wave; and
transmitting, by the first transmitting unit, a third transmission wave containing the signal included in the reflected wave to the second mobile body when the reflected wave is determined by the waveform determination unit to be due to the first transmission wave.

8. The object detection method according to claim 7, wherein the signal contained in the first transmission wave includes a chirp signal, and the determination signal includes a single frequency signal.

9. The object detection method according to claim 7, wherein the object detection system further comprises a waveform analysis unit, wherein the waveform analysis unit:
analyzes the waveform of the electromagnetic wave when it is determined by the waveform discrimination unit that the electromagnetic wave is not the first transmission wave transmitted from a second mobile body, and
analyzes the waveform of the reflected wave when it is determined by the waveform determination unit that the reflected wave is not due to the first transmission wave.

10. The object detection method according to claim 7,
wherein the object detection system further comprises a frequency correction unit;
wherein the signal included in the first transmission wave contains a chirp signal; and
wherein the frequency correction unit performs frequency correction on the chirp signal when it is determined by the waveform discrimination unit that the electromagnetic wave is a first transmission wave transmitted from the second mobile body.

11. The object detection method according to claim 7,
wherein the object detection system further comprises a frequency correction unit;
wherein the signal included in the reflected wave contains a chirp signal; and
wherein the frequency correction unit performs frequency correction on the chirp signal when it is determined by the waveform determination unit that the reflected wave is due to the first transmission wave.

12. The object detection method according to claim 7,
wherein the first receiving unit and the first transmitting unit are arranged on the rear side of the first mobile body, and the first receiving unit receives electromagnetic wave transmitted from the rear direction of the first mobile body; and
wherein the second receiving unit and the second transmitting unit are arranged on the front side of the first mobile body, and the second transmitting unit transmits the second transmission wave to the front direction of the first mobile body.
